(19) United States
(12) Patent Application Publication
(10) Pub. No.: US 2026/0031322 A1
(43) Pub. Date: Jan. 29, 2026

(54) SOLVENT-FREE ELECTRODE

(71) Applicant: FORD GLOBAL TECHNOLOGIES, LLC, Dearborn, MI (US)

(72) Inventors: Insik JEON, Novi, MI (US); Jonghwan PARK, Ann Arbor, MI (US); Wei XU, Livonia, MI (US); Chi PAIK, Grosse Ile, MI (US)

(21) Appl. No.: 18/780,991

(22) Filed: Jul. 23, 2024

(51) Int. Cl. H01M 4/04; H01M 4/02; H01M 4/131; H01M 4/1391; H01M 4/36; H01M 4/525; H01M 4/62; H01M 10/0525

(52) U.S. Cl. CPC H01M 4/0419; H01M 4/0404; H01M 4/0435; H01M 4/131; H01M 4/1391; H01M 4/366; H01M 4/525; H01M 4/623; H01M 4/625; H01M 10/0525; H01M 2004/028

(57) ABSTRACT

The present disclosure relates to a lithium-ion battery component and methods for manufacturing the lithium-ion battery component. The battery component, in some examples, includes a current collector, a porous deposit of first active material and first binder on the current collector, and a solvent-free electrode layer of second active material and second binder laminated with the porous deposit to at least partially occupy the pores of the porous deposit.

### TECHNICAL FIELD

This disclosure relates to solvent-free electrodes for battery cells.

### BACKGROUND

Conventional methods for manufacturing electrodes involve applying a mixture of active materials, conductive additives, and binders onto a metal current collector foil using a solvent-based coating process. The coated electrode is then dried to remove the solvent, leaving a solid electrode film adhered to the current collector. While widely used, this solvent-based electrode coating process may have several drawbacks.

### SUMMARY

In one aspect of the disclosure, a lithium-ion battery component is presented. The lithium-ion battery component includes a current collector, a porous deposit of the first active material and a first binder on the current collector, and a solvent-free electrode layer of second active material and a second binder laminated with the porous deposit to at least partially fill the pores of the porous deposit. The first active material and the second active material may be selected from a group including lithium-rich manganese-rich oxide, nickel cobalt manganese oxide, lithium iron phosphate, lithium manganese iron phosphate, lithium cobalt oxide, lithium nickel cobalt aluminum oxide, and lithium manganese nickel oxide. Alternatively, the first and second active materials may be chosen from graphite, silicon, silicon-carbon composites, and silicon oxide. The first binder may be selected from polyvinylidene fluoride, hydrogenated nitrile butadiene rubber, acrylics, styrene-butadiene rubber, carboxymethyl cellulose, polyimide, polyamide, polyurethane, polyacrylonitrile, polyvinyl alcohol, and their combinations. The second binder may include fluoropolymers such as polytetrafluoroethylene and polyvinylidene fluoride, polyethylene oxide, polyolefins, paraffin wax, polylactic acid, polycarbonate, acrylonitrile-butadiene-styrene, acrylics, polyimide, polyamide, polyurethane, and their combinations. The solidified suspension further includes a first conductive additive such as carbon black, multi-walled carbon nanotubes, single-walled carbon nanotubes, and carbon nanosheets. The electrode layer also comprises a second conductive additive from the same group. The loading of the porous deposit ranges from 0.1 mg/cm² to 20 mg/cm², while the loading of the electrode layer ranges from 1 mg/cm² to 50 mg/cm².

In another aspect of the disclosure, a method of manufacturing an electrode is presented. The method involves applying an electrode slurry containing a first active material, a first binder, a first conductive additive, and a solvent onto a current collector. The slurry is then dried to evaporate the solvent and form a first electrode layer. An electrode mixture of a second active material, a second binder, and a second conductive additive is applied onto the first electrode layer using a solvent-free dry coating process, forming a second electrode layer. The second electrode layer is compressed with the first electrode layer to form the electrode. The first electrode layer provides interfacial adhesion between the current collector and the second electrode layer. The second electrode mixture may be applied by electrostatic spray deposition, powder coating, dry tape casting, free-standing film lamination. The loading of the first electrode layer ranges from 0.1 mg/cm² to 20 mg/cm², and the loading of the second electrode layer ranges from 1 mg/cm² to 50 mg/cm². The first binder may be chosen from polyvinylidene fluoride, hydrogenated nitrile butadiene rubber, acrylics, styrene-butadiene rubber, carboxymethyl cellulose, polyimide, polyamide, polyurethane, polyacrylonitrile, polyvinyl alcohol, and their combinations. The second binder may be chosen from fluoropolymers such as polytetrafluoroethylene and polyvinylidene fluoride, polyethylene oxide, polyolefins, paraffin wax, polylactic acid, polycarbonate, acrylonitrile-butadiene-styrene, acrylics, polyimide, polyamide, polyurethane, and their combinations. The first and second conductive additives may include carbon black, multi-walled carbon nanotubes, single-walled carbon nanotubes, and carbon nanosheets. The first and second active materials may be selected from lithium-rich manganese-rich oxide, nickel cobalt manganese oxide, lithium iron phosphate, lithium manganese iron phosphate, lithium cobalt oxide, lithium nickel cobalt aluminum oxide, and lithium manganese nickel oxide, or alternatively from graphite, silicon, silicon-carbon composites, and silicon oxide.

In yet another aspect of the disclosure, a lithium-ion battery is presented. The lithium-ion battery includes a current collector and a pair of electrodes with the current collector disposed between them. At least one of the electrodes has a porous deposit of first active material and first binder on the current collector. The porous deposit provides interfacial adhesion between the current collector and a solvent-free electrode layer of second active material and second binder laminated with the porous deposit to at least partially occupy the pores of the porous deposit.

### BRIEF DESCRIPTION OF THE DRAWINGS

FIG. 1 is a schematic diagram of a lithium-ion battery according to one or more aspects of the disclosure;

FIG. 2 is a schematic diagram of a manufacturing process according to one or more aspects of the disclosure;

FIG. 3 is a schematic diagram of a manufacturing process according to one or more aspects of the disclosure;

FIG. 4 is a schematic diagram of a manufacturing process according to one or more aspects of the disclosure;

FIG. 5 is a schematic diagram of a manufacturing process according to one or more aspects of the disclosure;

FIG. 6 is a table showing composition and adhesion properties of electrodes according to one or more aspects of the disclosure;

FIG. 7 is a graph showing adhesion strength of electrodes according to one or more aspects of the disclosure; and

FIG. 8 is a flowchart of a method of forming an electrode according to one or more aspects of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, a stated dimension of “10 mm” should be interpreted as “about 10 mm.” Similarly, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

The present disclosure relates to methods for manufacturing high performance lithium-ion battery electrodes using a hybrid solvent-based and solvent-free coating process. Current methods for manufacturing electrodes involve applying a mixture of active materials, conductive additives, and binders onto a metal current collector foil using a solvent-based coating process. The coated electrode is then dried to remove the solvent, leaving a solid electrode film adhered to the current collector. This solvent-based electrode coating process may involve the use of volatile solvents, have long drying times, and result in a need for solvent recovery and disposal methods.

The present disclosure addresses these limitations by providing a hybrid electrode structure and manufacturing method that combines a thin solvent-coated electrode layer with a thicker solvent-free coated electrode layer. The hybrid electrode includes both cathode and anode configurations. In one aspect of the disclosure, the hybrid electrode has a current collector foil, a first electrode layer coated on the current collector foil using a solvent-based coating process, and a second electrode layer coated on top of the first electrode layer using a solvent-free coating process. The first electrode layer serves as an adhesion promoter between the current collector and the second electrode layer, while still contributing to the electrochemical performance of the electrode. The loading of the first electrode layer is kept relatively low, typically in the range of 0.1 to 20 mg/cm², and preferably between 0.5 and 10 mg/cm². This allows the first electrode layer to be dried rapidly, without the need for extensive solvent recovery.

The second electrode layer is coated on top of the first electrode layer using a solvent-free coating process, such as dry powder coating or electrostatic spray deposition. The loading of the second electrode layer is typically higher than that of the first electrode layer, allowing the second layer to provide the majority of the electrode's electrochemical capacity. The first and second electrode layers are then calendared simultaneously to enhance the interfacial adhesion between the two layers.

The binder materials used in the first and second electrode layers are selected to provide good adhesion, cohesion, and electrochemical stability. Suitable binders for the first electrode layer include polyvinylidene difluoride (PVDF), hydrogenated nitrile butadiene rubber (HNBR), acrylic polymers, styrene-butadiene rubber (SBR), carboxymethyl cellulose (CMC), polyimide, polyamide, polyurethane, polyacrylonitrile (PAN), polyvinyl alcohol (PVA), and combinations thereof. The binder content in the first layer is typically in the range of 0.1 to 10 wt. %, and preferably between 0.1 and 5 wt. %.

Binders for the second electrode layer include fluoropolymers such as polytetrafluoroethylene (PTFE), PVDF, ethylene tetrafluoroethylene (ETFE), and fluorinated ethylene propylene (FEP), as well as polyethylene oxide (PEO), polyolefins, paraffin wax, polylactic acid, polycarbonate, acrylonitrile-butadiene-styrene (ABS), acrylic polymers, polyimide, polyamide, polyurethane, and combinations thereof. The binder content in the second layer is typically in the range of 0.1 to 20 wt. %, and preferably between 0.1 and 10 wt. %. Both the first and second electrode layers include conductive additives to enhance the electrical conductivity of the electrode. Suitable conductive additives include carbon black (CB), multi-walled carbon nanotubes (MWCNT), single-walled carbon nanotubes (SWCNT), carbon nanofibers (CNF), and combinations thereof.

The active materials used in the cathode layers include lithium metal oxide compounds such as lithium manganese rich oxide (LMR), nickel cobalt manganese oxide (NCM), lithium iron phosphate, lithium manganese iron phosphate (LMFP), lithium cobalt oxide (LCO), lithium nickel cobalt aluminum oxide (NCA), lithium nickel oxide (LNO), lithium manganese nickel oxide (LMNO), and combinations thereof. For the anode layers, suitable active materials include graphite, silicon-carbon composites (Si/C), silicon oxide (SiOx), and combinations thereof.

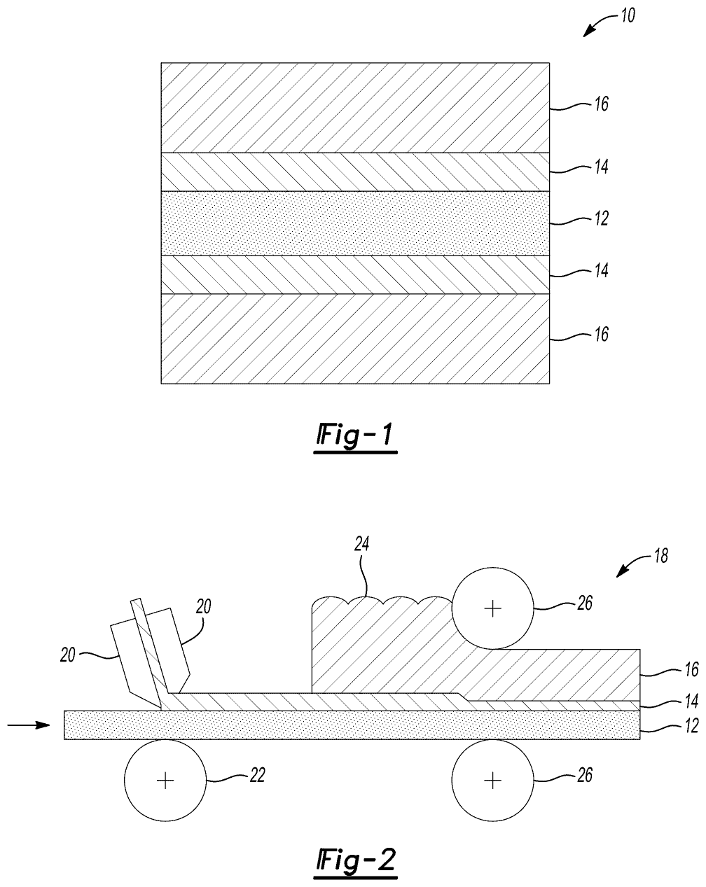

Referring to FIGS. 1-5, FIG. 1 is a schematic diagram of a lithium-ion battery 10 according to one or more aspects of the disclosure. The battery 10 has a current collector 12, a solvent-based electrode layer 14 coated on the current collector 12, and a solvent-free electrode layer 16 laminated on top of the solvent-based electrode layer 14. This hybrid electrode structure is applicable to both cathode and anode configurations. The solvent-based electrode layer 14 serves as an adhesion promoter between the current collector 12 and the solvent-free electrode layer 16, while still contributing to the electrochemical performance of the electrode. The loading of the solvent-based electrode layer 14 is kept relatively low, typically in the range of 0.1 to 20 mg/cm², and preferably between 0.5 and 10 mg/cm². This allows the solvent-based electrode layer 14 to be dried rapidly, without the need for extensive solvent recovery. The solvent-free electrode layer 16 is coated on top of the solvent-based electrode layer 14 and provides the majority of the electrode's electrochemical capacity. The solvent-based electrode layer 14 and the solvent-free electrode layer 16 may be calendared simultaneously to enhance the interfacial adhesion between the two layers. The solvent-based electrode layer 14, being the first electrode layer on the current collector 12, has a lower density due to its porosity than the solvent-free electrode layer 16 and provides an adhesion-promoting interface between the current collector 12 and the solvent-free electrode layer 16.

FIG. 2 is a schematic representation of a manufacturing process 18 according to one or more aspects of the disclosure. The manufacturing process 18 is a coating and powder lamination process. The manufacturing process 18 involves a coating and powder lamination approach. A slot-die 20 is used to deposit the solvent-based electrode layer 14 onto the current collector 12. The solvent-based electrode layer 14 is then laminated with the current collector 12 using a calendar 22. Subsequently, the solvent-free electrode layer 16 in powder form 24 is pressed on top of the solvent-based electrode layer 14 with a compression cylinder 26, forming a hybrid electrode structure with improved interfacial adhesion.

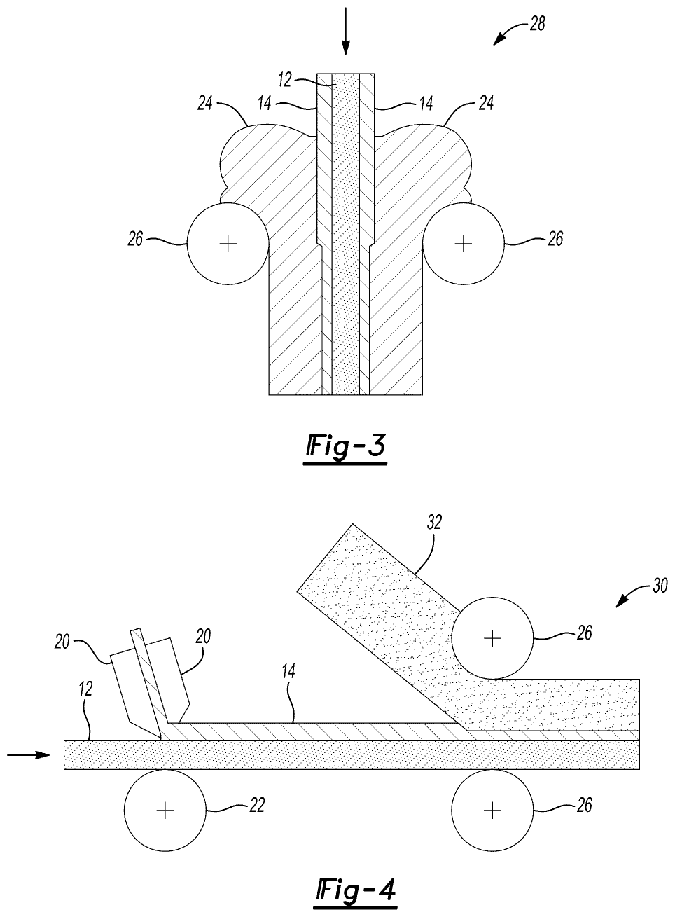

FIG. 3 is a schematic representation of a manufacturing process 28 according to one or more aspects of the disclosure. The manufacturing process 28 is a simultaneous lamination process. In this simultaneous lamination manufacturing process 28, the solvent-based electrode layer 14 is applied onto the current collector 12. Concurrently, the solvent-free electrode layer 24 is laminated on top of the solvent-based electrode layer 14, allowing for efficient production of the hybrid electrode in a single step.

FIG. 4 is a schematic representation of a manufacturing process 30 according to one or more aspects of the disclosure. The manufacturing process 30 is a coating and free-standing film lamination process. In the manufacturing process 30, the solvent-based electrode layer 14 is coated onto the current collector 12 via the slot-die 20. Separately, a free-standing solvent-free electrode film 32 is prepared with a solvent-free process. The free-standing solvent-free electrode film 32 is then laminated onto the solvent-based electrode layer 14 to form the hybrid electrode structure with enhanced interfacial adhesion.

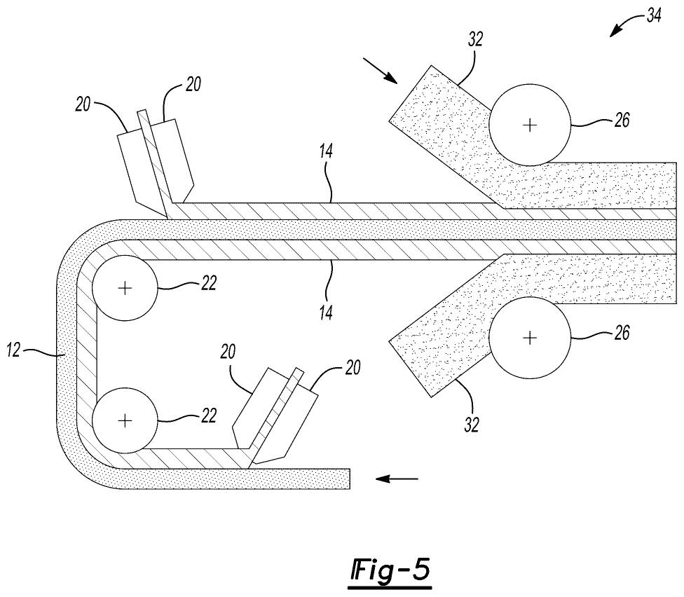

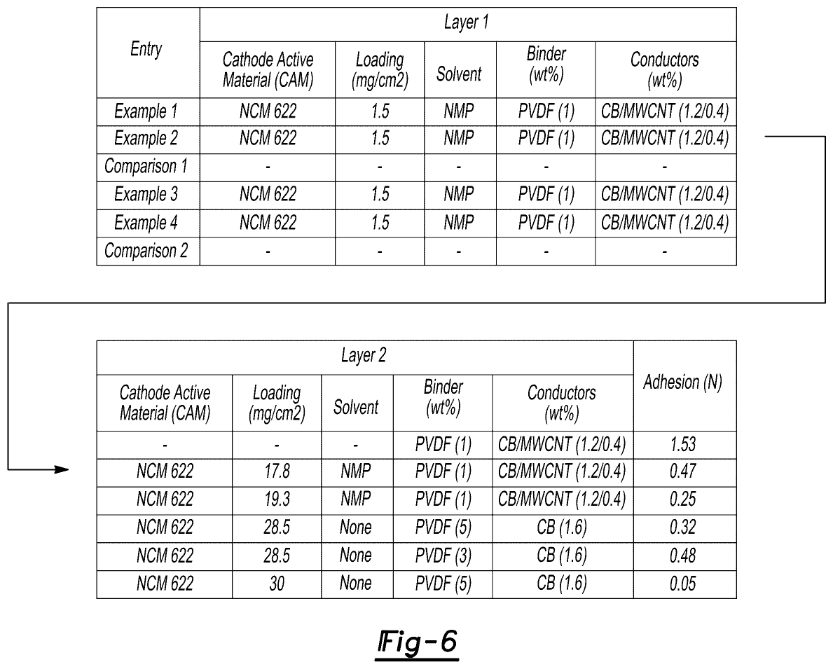

FIG. 5 a schematic representation of a manufacturing process 34 according to one or more aspects of the disclosure. The manufacturing process 34 is a coating and simultaneous free-standing film lamination process. A solvent-based electrode layer 14 is coated onto a current collector 12 using a slot-die 20. Concurrently, a free-standing solvent-free electrode film 32 is prepared separately. The free-standing solvent-free electrode film 32 is then laminated onto the freshly coated solvent-based electrode layer 14 using a calendar 22. This simultaneous coating and lamination process allows for efficient production of the hybrid electrode structure, ensuring good interfacial adhesion between the solvent-based electrode layer 14 and the free-standing solvent-free electrode film 32.

The binders used in the solvent-based electrode layer 14 may include PVDF, HNBR, acrylics, SBR, CMC, polyimide, polyamide, polyurethane, PAN, PVA, and combinations thereof. The binder content in the solvent-based electrode layer 14 is typically in the range of 0.1 to 10 wt. %, and preferably between 0.1 and 5 wt. %.

The binders used in the solvent-free electrode layer 16 or the free-standing solvent-free electrode film 32 may include fluoropolymers (PTFE, PVDF, ETFE, FEP), PEO, polyolefins, paraffin wax, polylactic acid, polycarbonate, ABS, acrylics, polyimide, polyamide, polyurethane, and combinations thereof. The binder content in the solvent-free electrode layer 16 is in the range of 0.1 to 20 wt. %, and preferably between 0.1 and 10 wt. %.

Both the solvent-based electrode layer 14 and the solvent-free electrode layer 16 include conductive additives to enhance the electrical conductivity of the electrode. The conductive additives may be CB, MWCNT, SWCNT, carbon nanosheets, or combinations thereof. The active materials used in the cathode layers include LMR, NCM, LMFP, LCO, NCA, LMNO, or combinations thereof. For the anode layers, the active materials include graphite, Si/C, SiOx, or combinations thereof.

FIG. 6 shows a comparative data table showing the composition and adhesion properties of hybrid solvent-based/solvent-free electrodes according to one or more embodiments of the present disclosure, as well as comparative solvent-free electrodes. The table includes data for four example embodiments of the hybrid electrodes (Examples 1-4) and two comparative examples of currently available solvent-free electrodes (Comparisons 1-2). For each entry, the table specifies the composition of the first solvent-based electrode layer (Layer 1) and the second solvent-free electrode layer (Layer 2), as well as the measured electrode adhesion strength.

Layer 1 composition data includes the cathode active material (CAM) type and loading (in mg/cm²), the solvent type, the binder type and weight percentage (wt. %), and the conductor type and weight percentage (wt. %). For the example embodiments, the cathode active material in Layer 1 is NCM (NCM 622) with a loading of 1.5 mg/cm². The solvent is N-methyl-2-pyrrolidone (NMP). The binder is PVDF at a weight percentage of 1 wt. % for Examples 1-2 and 1.5 wt. % for Examples 3-4. The conductor is a mixture of CB at 1.2 wt. % and MWCNT at 0.4 wt. %.

Layer 2 composition data similarly includes the cathode active material type and loading, solvent type (if any), binder type and weight percentage, and conductor type and weight percentage. For the hybrid electrode examples, the cathode active material in Layer 2 is NCM 622 with loadings ranging from 17.8 to 28.5 mg/cm². No solvent is used in Layer 2, as it is a solvent-free coating. The binder is either PVDF at 1 wt. % (Examples 2-3) or PTFE at 5 wt. % for Example 3 and PTFE at 3 wt. % for Example 4. The conductor is a mixture of CB and MWCNT for Example 2, and only CB at 1.6 wt. % for Examples 3-4. The comparative solvent-free electrodes (Comparisons 1-2) use NCM 622 as the cathode active material with loadings of 19.3 and 30 mg/cm², respectively. The binder is PVDF at 1 wt. % for Comparison 1 and PTFE at 5 wt. % for Comparison 2. The conductor is a mixture of CB at 1.2 wt. % and MWCNT at 0.4 wt. % for Comparison 1 and CB at 1.6 wt. % for Comparison 2.

The last column of the table reports the measured adhesion strength between the electrode layer and the current collector, in newtons (N). The hybrid electrode examples exhibit improved adhesion compared to the solvent-free comparisons. Example 2, with a thin NCM 622 solvent-based layer and a thicker NCM 622 solvent-free layer achieved an adhesion strength of 0.47 N, more than double that of the similar solvent-free electrode in Comparison 1 (0.25 N). Examples 3 and 4, using PTFE binder in the solvent-free layer, achieved even higher adhesion strengths of 0.32 N and 0.48 N, respectively, compared to just 0.05 N for the PTFE-based solvent-free electrode in Comparison 2.

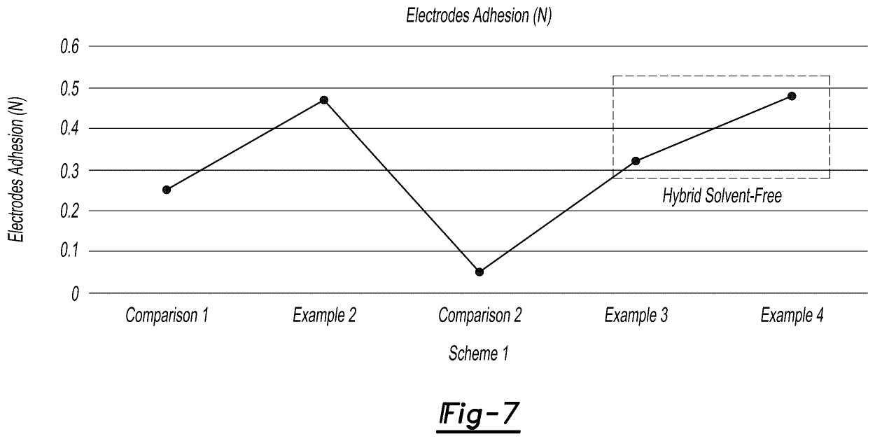

FIG. 7 is a graph comparing the electrode adhesion strength of currently available solvent-free electrodes (Comparisons 1 and 2) and hybrid solvent-based/solvent-free electrodes according to embodiments of the present disclosure (Examples 2, 3, and 4). The y-axis represents the electrode adhesion strength measured in N, while the x-axis shows the different electrode configurations being compared. Comparison 1, a currently available solvent-free electrode using PVDF binder, exhibits an adhesion strength of approximately 0.25 N. Comparison 2, another solvent-free electrode using PTFE binder, has an even lower adhesion strength of about 0.05 N.

The hybrid electrodes according to the present disclosure show improved adhesion. Example 2, which includes a solvent-based NCM 622 layer and a solvent-free NCM 622 layer with PVDF binder, achieves an adhesion strength of around 0.47 N. Examples 3 and 4, both featuring a solvent-based NCM 622 layer and a solvent-free NCM 622 layer with PTFE binder, demonstrate adhesion strengths of approximately 0.32 N and 0.48 N, respectively. The dashed lines in the graph highlight the clear separation in adhesion performance between the currently available solvent-free electrodes and the hybrid solvent-based/solvent-free electrodes of the present disclosure.

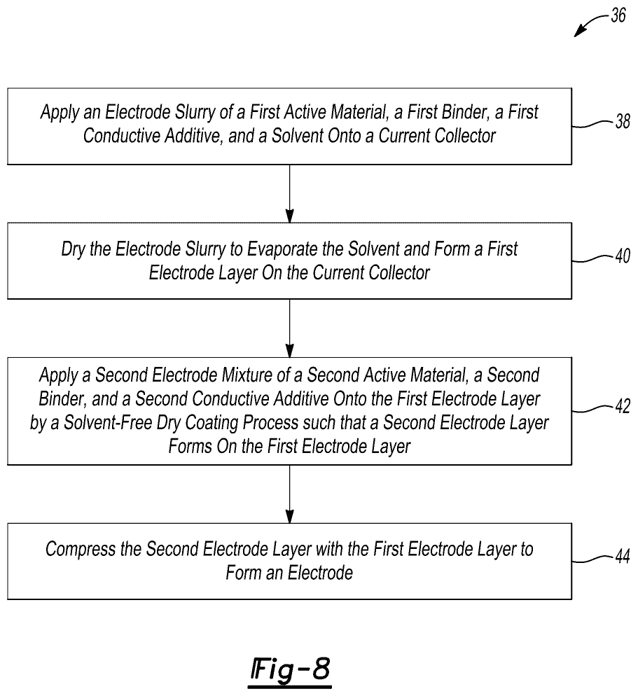

FIG. 8 is a flowchart of a method 36 of forming an electrode according to one or more aspects of the disclosure. The method 36 begins with block 38 which involves applying an electrode slurry, having a first active material, a first binder, a first conductive additive, and a solvent, onto a current collector. This step ensures that the initial layer of the electrode is uniformly coated on the current collector. Then in block 40, the electrode slurry is dried to evaporate the solvent, thereby forming a first electrode layer on the current collector. This drying process solidifies the first electrode layer, providing a stable base for subsequent layers.

Next, in block 42 a second electrode mixture, consisting of a second active material, a second binder, and a second conductive additive, is applied onto the first electrode layer through a solvent-free dry coating process. This method allows the second electrode layer to form directly on the first electrode layer without the use of additional solvents, which may simplify the manufacturing process and enhance the structural integrity of the electrode. In block 44, the second electrode layer is compressed with the first electrode layer to form a cohesive and durable electrode. This ensures strong adhesion between the two layers, enhancing the overall performance and longevity of the electrode in a lithium-ion battery.

The lithium-ion battery component includes a current collector with a porous deposit of the first active material and the first binder, and a solvent-free electrode layer of the second active material and the second binder laminated with the porous deposit to at least partially occupy the pores of the porous deposit. The first and second active materials may be selected from various groups, including lithium-rich manganese-rich oxide, nickel cobalt manganese oxide, lithium iron phosphate, lithium cobalt oxide, lithium nickel cobalt aluminum oxide, lithium manganese nickel oxide, graphite, silicon-carbon composites, and silicon oxide. The binders may be chosen from a wide range of materials, such as polyvinylidene fluoride, hydrogenated nitrile butadiene rubber, fluoropolymers, polyethylene oxide, and others, ensuring versatility and compatibility with different battery chemistries.

Additionally, the solidified suspension and the electrode layer may include conductive additives like CB and carbon nanotubes to enhance electrical conductivity. The loading of the porous deposit ranges from 0.1 mg/cm² to 20 mg/cm², while the loading of the electrode layer ranges from 5 mg/cm² to 50 mg/cm², providing flexibility in the design and optimization of the electrode's performance characteristics.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lithium-ion battery component comprising:
a current collector;
a porous deposit of first active material and first binder on the current collector; and
a solvent-free electrode layer of second active material and second binder laminated with the porous deposit to at least partially occupy pores of the porous deposit.

2. The lithium-ion battery component of claim 1 wherein the first active material and the second active material are selected from a group including: lithium-rich manganese-rich oxide, nickel cobalt manganese oxide, lithium iron phosphate, lithium, manganese iron phosphate, lithium cobalt oxide, lithium nickel cobalt aluminum oxide, and lithium manganese nickel oxide.

3. The lithium-ion battery component of claim 1 wherein the first active material and the second active material are selected from a group including: graphite, silicon, silicon-carbon composites, and silicon oxide.

4. The lithium-ion battery component of claim 1 wherein the first binder is selected from a group including: polyvinylidene fluoride, hydrogenated nitrile butadiene rubber, acrylics, styrene-butadiene rubber, carboxymethyl cellulose, polyimide, polyamide, polyurethane, polyacrylonitrile, polyvinyl alcohol, and combinations thereof.

5. The lithium-ion battery component of claim 1 wherein the second binder is selected from a group including: fluoropolymers such as polytetrafluoroethylene and polyvinylidene fluoride, polyethylene oxide, polyolefins, paraffin wax, polylactic acid, polycarbonate, acrylonitrile-butadiene-styrene, acrylics, polyimide, polyamide, polyurethane, and combinations thereof.

6. The lithium-ion battery component of claim 1 wherein the porous deposit further includes a first conductive additive selected from a group including: carbon black, multi-walled carbon nanotubes, single-walled carbon nanotubes, and carbon nanosheets.

7. The lithium-ion battery component of claim 1 wherein the solvent-free electrode layer further comprises a second conductive additive selected from a group including: carbon black, multi-walled carbon nanotubes, single-walled carbon nanotubes, and carbon nanosheets.

8. The lithium-ion battery component of claim 1 wherein a loading of the porous deposit is in a range of 0.1 mg/cm² to 20 mg/cm².

9. The lithium-ion battery component of claim 1 wherein a loading of the solvent-free electrode layer is in a range of 1 mg/cm² to 50 mg/cm².

10. A method of manufacturing an electrode comprising:
applying an electrode slurry of a first active material, a first binder, a first conductive additive, and a solvent onto a current collector;
drying the electrode slurry to evaporate the solvent and form a first electrode layer on the current collector;
applying an electrode mixture of a second active material, a second binder, and a second conductive additive onto the first electrode layer by a solvent-free dry coating process such that a second electrode layer forms on the first electrode layer; and
compressing the second electrode layer with the first electrode layer to form an electrode.

11. The method of claim 10 wherein the first electrode layer is configured to provide interfacial adhesion between the current collector and the second electrode layer.

12. The method of claim 10 further comprising applying the electrode mixture by an electrostatic spray deposition, a powder coating, a dry tape casting process, or a free-standing film lamination.

13. The method of claim 10 wherein a loading of the first electrode layer is in a range of 0.1 mg/cm2 to 20 mg/cm2.

14. The method of claim 10 wherein a loading of the second electrode layer is in a range of 1 mg/cm2 to 50 mg/cm2.

15. The method of claim 10 wherein the first binder is selected from a group including: polyvinylidene fluoride, hydrogenated nitrile butadiene rubber, acrylics, styrene-butadiene rubber, carboxymethyl cellulose, polyimide, polyamide, polyurethane, polyacrylonitrile, polyvinyl alcohol, and combinations thereof.

16. The method of claim 10 wherein the second binder is selected from a group including: fluoropolymers such as polytetrafluoroethylene and polyvinylidene fluoride, polyethylene oxide, polyolefins, paraffin wax, polylactic acid, polycarbonate, acrylonitrile-butadiene-styrene, acrylics, polyimide, polyamide, polyurethane, and combinations thereof.

17. The method of claim 10 wherein the first conductive additive and the second conductive additive are selected from a group including: carbon black, multi-walled carbon nanotubes, single-walled carbon nanotubes, and carbon nanosheets.

18. The method of claim 10 wherein the first active material and the second active material are selected from a group including: lithium-rich manganese-rich oxide, nickel cobalt manganese oxide, lithium iron phosphate, lithium manganese iron phosphate, lithium cobalt oxide, lithium nickel cobalt aluminum oxide, and lithium manganese nickel oxide.

19. The method of claim 10 wherein the first active material and the second active material are selected from a group including: graphite, silicon, silicon-carbon composites, and silicon oxide.

20. A lithium-ion battery comprising:
a current collector; and
a pair of electrodes with the current collector disposed between the electrodes, wherein at least one of the electrodes has a porous deposit of first active material and first binder on the current collector, and wherein the porous deposit is configured to provide interfacial adhesion between the current collector and a solvent-free electrode layer, of second active material and second binder, laminated with the porous deposit to at least partially occupy pores of the porous deposit.
